(19) United States
(12) Patent Application Publication
(10) Pub. No.: US 2008/0063024 A1
(43) Pub. Date: Mar. 13, 2008

(54) Control Device for Ac Reduction Furnaces

(76) Inventors: Thomas Pasch, Erkrath (DE); Juergen Kunze, Xanten (DE); Dieter Borgwardt, Dorsten (DE)

Correspondence Address: ABELMAN, FRAYNE & SCHWAB, 666 THIRD AVENUE, 10TH FLOOR, NEW YORK, NY, 10017, US

(21) Appl. No.: 11/884,212

(22) PCT Filed: Oct. 11, 2006
(86) PCT No.: PCT/EP06/09807

§ 371 Date: Aug. 9, 2007

(30) Foreign Application Priority Data
Oct. 26, 2005 (DE) 10 2005 051 232.1

(51) Int. Cl. H05B 7/148

(52) U.S. Cl. 373/105

(57) ABSTRACT

The invention is directed to a control device for AC reduction furnaces (15) with electrodes (14) having a transformer (11) and a regulating system (1) for the controlled introduction of energy into the AC reduction furnaces (15) which controls an adjusting device (17) for the electrodes (14). The control device further has controllable power-electronics AC switches (13) which are connected in the high-current conductors on the secondary side and are connected to the regulating system (1) by an ignition line (16) for supplying controlling ignition pulses. The control device is constructed in such a way that brief fluctuations in the electric parameters are compensated only by the AC switches (13).

The invention is directed to a control device for AC reduction furnaces with electrodes which has a transformer and a regulating system for the controlled input of energy into the AC reduction furnaces, which regulating system controls an adjusting device for the electrodes.

Electric reduction furnaces of the type mentioned above which can be provided with six electrodes connected in pairs in single-phase or with three electrodes in a knapsack circuit or star circuit are used for the production of nonferrous metals, iron alloys and process slag.

Heretofore, the input of electric energy into the reduction furnace was regulated by hydraulic adjustment of the electrodes. To this end, the bath resistance is influenced by changing the depth to which the electrode is immersed in the charge and/or—in arc mode—by the resistance ratios below the electrodes. The measured electrode currents, the impedances determined from the respective electrode currents and electrode voltages, or the calculated resistances based on the primary-side measurements of the electric quantities are used as regulating variables. The adjustment of the electrode voltage is carried out by steps by changing the transmission ratio of the transformer windings by means of load tap changers.

With this electrode regulation, the furnace power is subject to sharp fluctuations caused by continual process-dependent changes in the bath resistances when the electrodes are immersed and/or, in arc operation, by changes in the resistance ratios when the electrodes are not immersed. As a result of these permanent fluctuations of currents, voltages and powers, the electric energy is introduced into the furnace in an inhomogeneous manner.

Further, various processes for the production of nonferrous metals and iron alloys require that reaction spaces are formed below the electrodes. Frequent mechanical movements of the electrodes for regulating the electric parameters interfere with these reaction spaces and impede the metallurgical melting and reduction process.

DE 43 09 640 A1 describes a DC arc furnace with a voltage regulating circuit which is subordinated to the current regulating circuit. The actual value for the voltage regulator is formed from the voltage present at the power converter, and the reference value is formed from the output voltage of the current regulator, and a filter adapted to the flicker frequency is arranged downstream of the voltage regulator. The DC arc furnace is also supposed to enable flicker-free operation in case of weak grid power supplies, that is, those with small short-circuit powers.

DE 41 35 059 A1 is directed to an apparatus for continuous electric voltage control to reduce the harmonic content in the controlled voltage. Further, the load voltage can be adjusted more sensitively and can be adapted quickly to a variable impedance. An AC power controller used for controlling voltage need not be dimensioned for the full power of the load; no currentless phases occur in the load current which could generate erratic and unstable arc operation, e.g., in an electric reduction furnace, and a variable reactive power because of load fluctuations. The apparatus is particularly suited to the operation of arc furnaces in which the load voltage must change quickly at constant arc current. It fluctuates from 100 V at the start of the melt to 500 to 700 V at a sufficient melt up to 1.2 kV voltage for strong arcs.

DE 35 08 323 C2 describes a device for supplying one or more electrodes of a single-phase or multiphase electrothermal furnace by means of main transformers and auxiliary transformers which reduces circuit feedback, facilitates the maintenance of a constant current, and—in multi-electrode furnaces—also enables individual control of the active power below the electrodes. The current is measured at the secondary winding for each phase, rectified and fed as an actual current value to an adding unit which carries out a subtraction between the reference current and the actual current; the regulating deviation is supplied to a regulator whose output signal is sent to a control pulse generator which generates corresponding ignition pulses for a single-phase thyristor setting device which is connected in series with an intermediate circuit winding of the main transformer and the associated primary winding. A device of this kind is applicable to arc furnaces and reduction furnaces.

DE 34 39 097 A1 discloses a regulating arrangement for a DC arc furnace with one or more electrodes as cathode and one or more arc electrodes as anode, wherein thyristors for rectifying the three-phase alternating current are arranged in a six-pulse or twelve-pulse bridge circuit. In this way, the fast, temporary current fluctuations can be compensated by current regulation and the slow and/or long-term fluctuations can be compensated by an adjusting device for the electrodes with voltage regulation. A thyristor device provides for a current regulation depending on the difference between the reference current value and the actual value of the electrode current and provides for a voltage regulation depending on the reference voltage value and the actual value of the electrode voltage, the voltage regulation being carried out more slowly than the current regulation and the adjustment of the electrodes.

This regulating arrangement was developed especially for the requirements of DC arcs for steel production in which the electric power is introduced in its entirety in the form of an arc for the melting process in the furnace.

The bottom electrodes required in DC furnaces are subject to extreme stress because of the problematic arrangement in the bottom of the furnace vessel. The bottom electrode is a weak point of the furnace and requires elaborate, reliable cooling. Changing the bottom electrodes in reduction furnaces is very time-consuming and cost-intensive.

The large-area loop of the high-current circuit of the DC arc furnace is penetrated by a magnetic flux through the electric current. The flux generates an electrodynamic force at the arc which deflects the arc in the direction opposite to the supply direction (arc deflection). This arc deflection causes increased wear on one side of the furnace lining in reduction furnaces.

DE 28 27 875 is directed to a multi-phase arc furnace and a method for regulation thereof. The required values for controlling the secondary side of the transformer are measured and calculated from determined primary-side and/or secondary-side measurements excluding the secondary phase voltages measured with respect to the furnace bath. The calculation of the desired regulating values is carried out under the assumption that the inductance behavior of the secondary windings is predictable amid other fluctuations of the arc furnace and that the regulating values calculated in this way are subject to certain boundary conditions depending on operation-oriented furnace variables. A device of this kind is usable in all multi-electrode furnaces. The primary-side phase voltages and star currents are measured; the secondary-side values are derived in such a way that these values can be used for improving regulation at least in many cases.

DE 20 34 874 A1 discloses an arrangement for supplying an arc furnace from the medium-voltage or high-voltage AC grid power in which the electrodes of the arc furnace are connected to the AC grid power via the furnace transformer and contactless, controllable electronic switches which regulate and—in case of overvoltage—interrupt the furnace current. In multiphase systems, the regulation helps to prevent asymmetric loading of the supply grid. The contactless, controllable electronic switches also substitute for the tap changers and intermediate tap changers of the furnace transformer.

DE 20 17 203 A1 describes an electric furnace for the electroslag refining process with consumable electrodes at currents of 3 Hz to 15 Hz in which an electric circuit is formed by the thyristor direct converter, three-phase transformer and furnace circuit with electrode and by the wall and intermediate circuit with single-phase transformer.

EP 0 589 544 B1 is directed to a three-phase arc furnace installation with series-connected chokes and a three-phase thyristor bride connected in parallel with the chokes as a controllable bridging switch, wherein the control unit, in connection with an electronic data processing system, processes not only electric data such as current, voltage, harmonic content and flicker but also process data and operates in response to a comparison of reference data to actual data.

EP 0 498 239 B1 discloses a method for electrode regulation of a DC arc furnace and electrode regulating device and a device in which the calculation of the reference value for the electrode regulation is bypassed in that, instead of the DC voltage, a signal proportional to the control angle is taken from the current regulator. This signal is fed through an attenuator which monitors threshold values in addition to the signal matching and filters out unwanted frequencies. The reference value corresponds to the mean control of the rectifier. The arc length is initiated independent from the change in voltage in such a way that the lengthened current is achieved by a predetermined controlling of the rectifier; there is always a sufficient regulating range available for keeping the current constant. A constant mean power factor is also achieved in the supply grid by regulating to constant control at the rectifier.

EP 0 429 774 A1 discloses a device and a method for supplying a multi-phase arc furnace with controlled current comprising a three-phase network, a controlled series reactance, a three-phase furnace transformer and an arc furnace with a hydraulic electrode regulating system. The phase current is measured by a current converter and fed to a thyristor-controlled inductor with a control device which in turn influences the series reactance in the main circuit. The electrode position and the transformer voltage are additional influencing measured signal quantities.

WO 02/28146 A1 describes an automatic electrode regulator based on direct power factor regulation and a method for an electric arc furnace having a furnace transformer comprising a transformer for measuring the operating current and voltage of the electrode, a converter for calculating the active power of the electrode, a converter for calculating the reactive power of the electrode, a programmable monitoring unit for calculating the power factor of the electrode and matching to a predetermined reference value, and an electrode height adjustment and measurement device with a signal connection to the monitoring unit for moving the electrode in such a way that the actual power factor approaches the reference value default as far as possible.

The electric parameters of the electric reduction furnaces are kept constant as far as possible by hydraulically raising and lowering the electrodes. However, these parameters fluctuate permanently due to the change in the bath resistance when the electrodes are immersed and/or the change in the resistance ratios in furnace operation with electrodes that are not immersed, namely, arc operation. Because of this, electric energy is introduced into the furnace in an inhomogeneous manner. Further, the construction of reaction spaces in the furnace is made more difficult by occasionally drastic electrode movements.

It is the object of the invention to construct a control device of the type mentioned in the beginning in such a way that the power input into the electric reduction furnace is stabilized and, therefore, the input of energy and production are increased. Further, the electrode movements are reduced to a minimum so that reaction spaces can be constructed without interference.

This object is met according to the invention in that the control device has controllable power-electronics AC switches which are connected in the high-current conductors on the secondary side and are connected to the regulating system by an ignition line for supplying controlling ignition pulses, wherein the control device is constructed in such a way that brief fluctuations in the electric parameters are compensated only by the AC switches. Since the regulation of the energy input is no longer carried out only by changing the electrode position but chiefly by means of controllable power-electronics switches connected in the high-current conductors on the secondary side, it is possible by means of controlling the phase angle of the power semiconductors to regulate the effective value of the secondary currents in a continuous manner. Phase angle control of the power semiconductors is very fast compared to the prior mechanical adjustment of the electrodes. It is possible in this way to respond faster to changes in the electric parameters of the process and therefore to stabilize the furnace output.

The aim of the mechanical adjustment of the electrodes is limited to the balancing of the voltage ratios of the bath voltages in case of gross deviations from default values and compensating for electrode consumption.

It has proven advantageous that the regulating system has a phase angle control of the power semiconductors which regulates the effective values of the secondary currents in a continuous manner.

The regulating system can advantageously be constructed in such a way that it regulates the effective values of the secondary currents in reduction furnaces in a knapsack circuit.

According to the invention, the power semiconductors can have antiparallel-connected thyristor sets so that a phase angle control of the three-phase AC current is carried out.

In contrast to the mechanical adjustment of the electrodes, the phase angle control of the power semiconductors can respond quickly to changes in the electric parameters of the furnace process and stabilize the furnace power.

The adjusting device for the electrodes can advantageously be constructed in such a way that the voltage ratios of the bath voltages are compensated in the event of gross deviations from the reference values and electrode consumption is compensated.

Optimal regulation is achieved when the current regulation and voltage regulation are extensively decoupled.

It has proven advantageous when the electrodes of the high-current system of the reduction furnace are connected in pairs in a star connection. Alternatively, the electrodes of the high-current system of the reduction furnace can be connected with a three-phase transformer or three single-phase transformers in a knapsack circuit. According to the invention, it is also possible to connect the electrodes of the high-current system of the reduction furnace in a triangle connection.

In a particularly advantageous manner, the regulating system can be constructed in such a way that the individual electrode currents can be limited for the baking of the Söderberg electrodes.

According to the invention, the regulating system can be constructed in such a way that the transformer currents can be limited to prevent damage from overcurrents, particularly in the voltage range below the power breakpoint, or the transformer power can be limited to prevent excessive temperatures and accordingly to prolong the life of the transformers, particularly in the voltage range above the current breakpoint.

Also, it is possible, according to the invention, to construct the regulating system in such a way that the reactive power can be limited to meet guaranteed values for the power factor.

The life of power switches and load tap changers is increased when the regulating system is constructed in such a way that the power switches and load tap changers are switchable in a virtually currentless state.

Disturbances of the metallurgic reaction spaces are reduced to a minimum when the regulating system is constructed in such a way that additional dead times and/or hysteresis which promote the formation of reaction spaces below the electrodes are additionally implemented in the adjustment of the electrodes. Frequent mechanical electrode movements for regulating the electric parameters interfere with these reaction spaces and hinder the metallurgic melting and reduction process.

The invention will be described more fully in the following with reference to embodiment examples shown in the drawing.

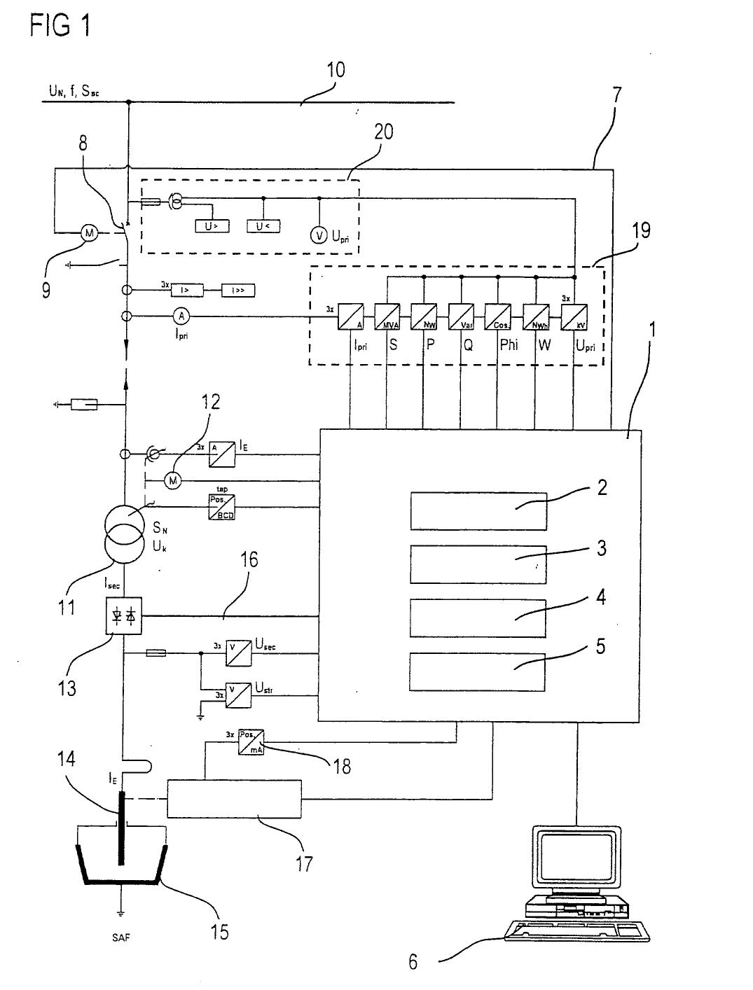

FIG. 1 shows a regulating system according to the invention for a single-phase construction;

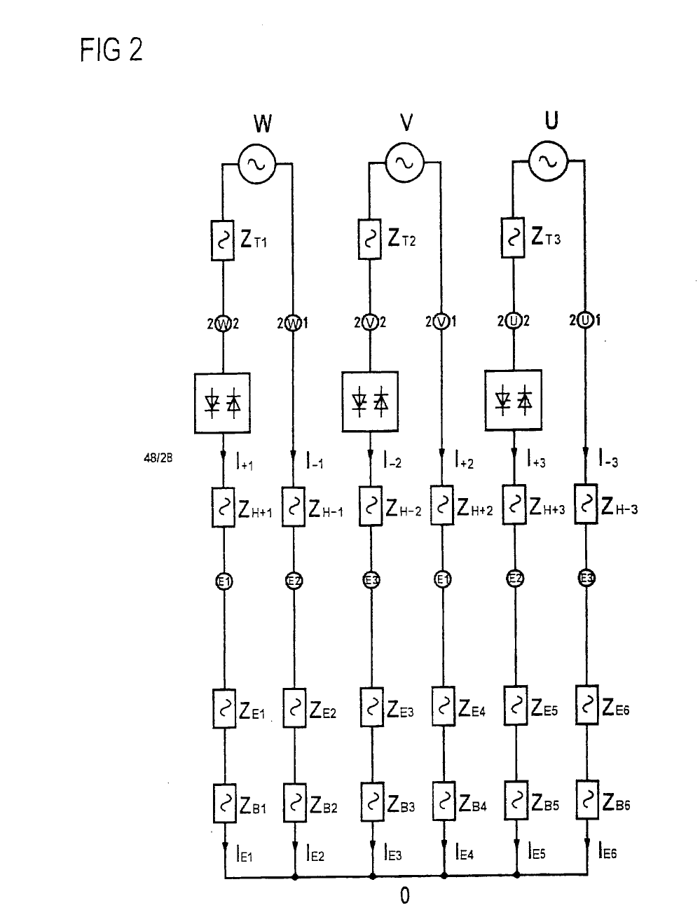

FIG. 2 shows a six-electrode furnace with electrodes connected in pairs;

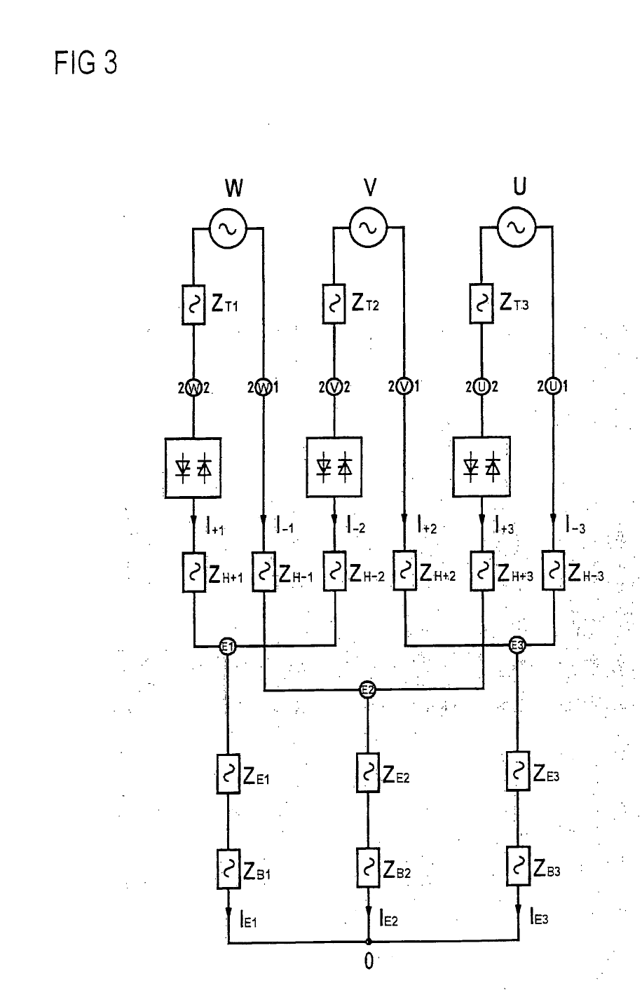

FIG. 3 shows a three-electrode furnace with a three-phase transformer in a knapsack circuit;

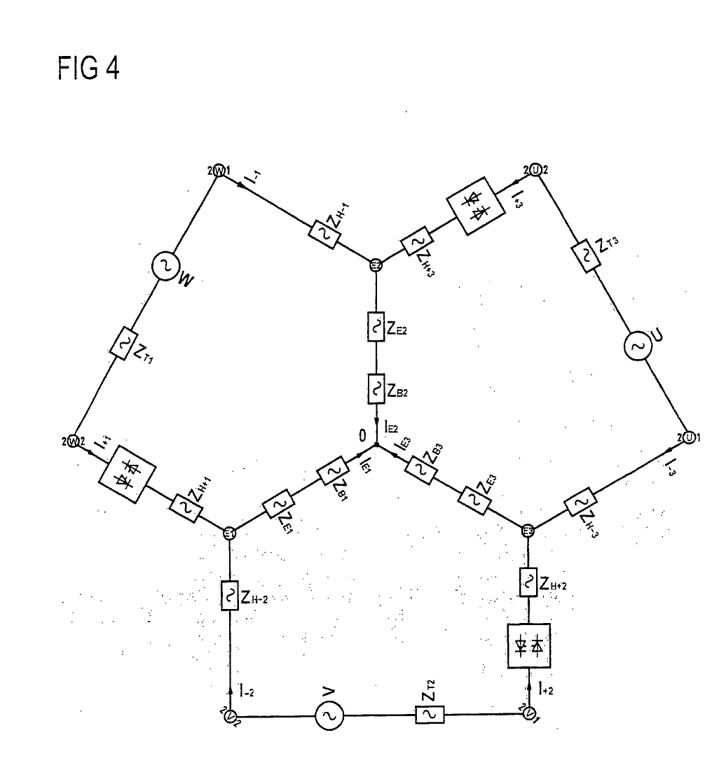

FIG. 4 shows a symmetrically constructed three-electrode reduction furnace with three single-phase transformers in a knapsack circuit; and

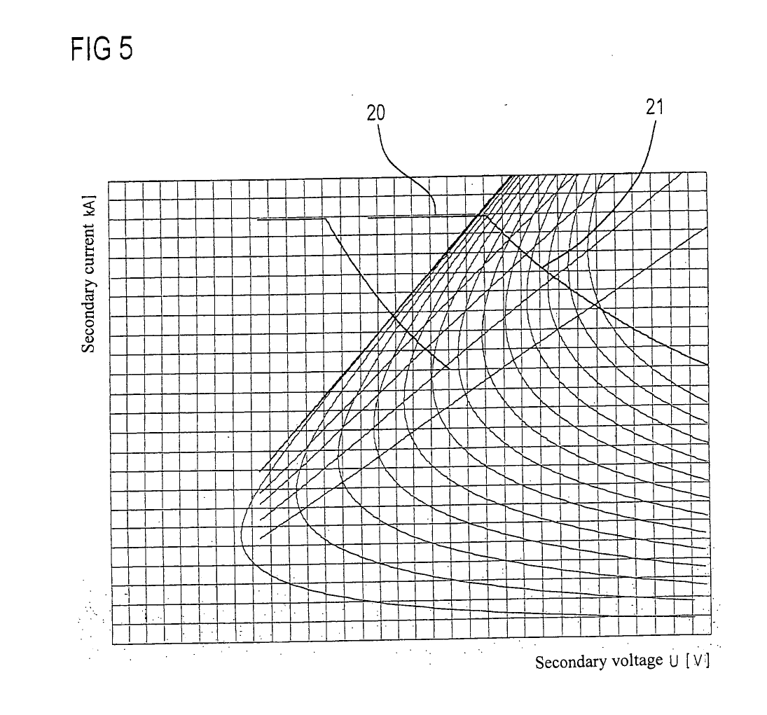

FIG. 5 shows a family of curves to illustrate the advantages of the invention.

FIG. 1 shows a regulating system 1 according to the invention which has a monitoring device 2, current regulating means 3, a phase angle control 4, and voltage regulating means 5. A personal computer 6 (PC), for example, is connected for controlling.

Only one phase of a three-phase system is shown in FIG. 1.

A furnace switch 9 can connect the furnace, described below, to the supply voltage 10 by a switching line 7 by means of a motor 9. This supply voltage 10 is then present at the primary side of a furnace transformer 11 whose tap changer switch can be regulated through the regulating system 1 by means of an adjusting device 12.

An electronic AC switch, a power semiconductor 13 which is connected to an electrode 14 that can be immersed in a bath of the grounded furnace 15, is connected to the secondary side of the furnace transformer 11.

The power semiconductor 13 can contain two antiparallel-connected power-electronics switches. Because of the high outputs of several MVA, thyristors can preferably be used as semiconductor components, but controllable power transistors can also be used. The power semiconductor 13 is supplied via an ignition line 16 for conducting with ignition pulses by the regulating system 1.

A hydraulic system 17 carries out a slow electrode regulation to correct the voltage ratios of the bath voltages in the event of gross deviations from reference values and to compensate for electrode consumption. A measuring device 18 supplies a signal corresponding to the position of the electrode 14 to the regulating system 1.

Devices 19 for measuring and monitoring the electric quantities are connected to the regulating system 1 and measured values corresponding to the primary voltage U_{PRI} and primary currents I_{PRI} are supplied to them. The measuring and monitoring devices 19 calculate the values required for the regulating system 1 from these measured values. A ground connection monitor 20 is connected to the supply voltage 10 in front of the furnace switch 8 and likewise supplies its measured values to the regulating system 1.

The regulating system 1 on which the invention is based can be realized in a memory-programmable control (SPS), a process control system (PLS), a personal computer (PC) 6 or other computer-assisted system. Primary-side and secondary-side measuring and monitoring devices 19 for the electric quantities and the position of the load tap changer and star-triangle switch, if any, serve as input quantities for the regulating system 1. The measurement of the electrode position can optionally be incorporated in the controlling and regulating system 1.

Output quantities of the regulating system 1 are control values for the hydraulic valves for raising and lowering the electrodes 14 and the control quantities for the control electronics of the phase angle control 4 of the power semiconductors 13.

The regulating system 1 can be expanded to incorporate the automatic adjustment of the load tap changers of the furnace transformers 11 in order to keep the necessary control angle α within limits and to prevent a gap in the current in arc operation and under partial load.

FIGS. 2 to 4 show the AC diagram of the three-phases of the high-current side. FIG. 2 shows a furnace 15 with six electrodes 14 which are connected in pairs by the power semiconductors 13 to the phases U, V, W of the secondary side of the furnace transformer 11.

FIG. 3 shows a furnace 15 with three electrodes 14 which is connected to a three-phase transformer in a knapsack circuit.

The construction of the high-current system illustrated in FIG. 4 shows three single-phase transformers and AC converters which are offset by 120° and an angle-symmetric layout of the high-current lines and arrangement of the electrode strings. Identical ratios of the respective impedances can be achieved by means of this consistently symmetric construction so as to facilitate the most uniform possible power input into the reduction furnace and accordingly to load the high-voltage supply grid as symmetrically as possible. Excellent compensation for process-dependent asymmetric loads can be achieved by means of the invention.

The knapsack circuit is used in electric reduction furnaces with three electrodes. In this knapsack circuit, the connections of the secondary windings of the furnace transformers are guided out and first connected to the three electrodes to form a triangle. The three electrodes now form a star-shaped load with the furnace bath. The furnace bath forms the point of the star. The furnace reactance is reduced by the arrangement of the high-current conductors which compensates for the magnetic field. In this way, an active power that is greater than the transformer power can be introduced into the furnace resulting in an improved power factor cos φ.

A single-phase controllable AC converter can be used in connection with single-phase furnace transformers, or three-phase controllable AC converter can be used in connection with three-phase furnace transformers. The power section of the AC converters for current regulation is realized per phase respectively by two antiparallel-connected power-electronics switches. Owing to the high outputs of several MVA, thyristors are preferably used as semiconductor components. But the use of controllable power transistors is also conceivable.

The knapsack circuit shown in FIGS. 3 and 4 has the advantage of a low-reactance connection of the high-current lines through compensating effects of the electric fields. In this way, the generated reactive power component of the reduction furnace can be reduced. However, in another possible circuit the secondary windings of the transformer are connected in a triangle with three secondary connections which are guided out to the high-current lines and connected by the electrode strings and the bath to form a star as is common, e.g., in arc furnaces for steel production.

In addition to the principal object of the invention described above, the following advantages are provided in addition:

1. Limiting the individual electrode currents for the baking of the Söderberg electrodes:

When starting the furnace or after electrode breakage it is important to limit the electrode current I_{E} depending on the progress of the baking and in order to prevent damage. By means of the AC converter, the optimal electrode current I_{E} after a given baking program can be fed through the electrode 14 and damage to the electrode 14 caused by overcurrents can be prevented. The mechanical adjustment of the electrode 14 can be determined in order to avoid a fresh break of the “green” Söderberg.

2. Limiting the transformer currents for preventing damage due to overcurrents, especially in the voltage range below the power breakpoint:

The transformers 11 are protected by overcurrent relays which trigger the furnace switch 8 in the event of overcurrents and interrupt the production operation. Depending on the respective voltage step, the associated maximum transformer current can be limited by means of software by the regulating system 1 according to the invention and the transformer can be prevented from being switched off by overcurrents. The straight portion 20 of the curve shown in FIG. 5 shows the current limiting as a function of the secondary voltage. FIG. 5 shows a family of curves which illustrates the interdependency of the secondary voltage and secondary current.

3. Limiting the transformer power for preventing excessive temperatures and accordingly prolonging the life of the transformers, especially in the voltage range above the current breakpoint:

When the maximum permissible apparent power is exceeded due to low bath resistances, the furnace transformers 11 can be damaged by excessive temperatures and the life of the furnace transformers 11 can be shortened. By means of the AC converter, the apparent power of the furnace transformers 11 can be limited by the AC power controller to the maximum value. This is achieved by limiting the current depending on the respective voltage step as can be seen, for example, from the second curve segment 21 in FIG. 5.

4. Limiting the reactive power to meet guaranteed values for the power factor:

It is often necessary to maintain limiting values for the power factor cos φ which are mutually agreed upon by the operator and the energy supplier. The regulating system can prevent dropping below the limiting value simply by reducing the furnace power.

5. Preventing and limiting asymmetric loading of the high-voltage grid supply due to furnace design and process-related causes:

The furnace geometry, e.g., rectangular furnaces, and/or the arrangement of electrodes 14 in series and/or the use of a three-phase transformer or three single-phase transformers in a series arrangement result in inevitable asymmetries in the layout of the high-current conductors and accordingly lead to different loss resistances and reactive resistances. However, asymmetric loads are also caused by varying resistance ratios of the bath in the reduction furnace for process-related reasons. These unwanted asymmetric supply grid loads can be corrected by the regulating system 1.

6. Prolonging the life of power switches and load tap changers by switching in an almost currentless state:

By switching the furnace switch 8 and voltage tap changers under load, the life of the electric operating equipment is usually reduced. Also, in case of weak networks, flicker phenomena can occur because of the high switching powers. Due to the regulating system 1 according to the invention, the power semiconductors 13 can be blocked before switching the furnace switch 8 or tap changers so that the power switches can be actuated in an almost currentless state. Only the idle current of the transformers 11 needs to be connected.

Further, because of the improved regulating behavior and the possibility of limiting the electrode current when starting the furnace 15, the otherwise large number of voltage steps can be reduced.

The control device according to the invention makes it possible to operate a three-phase furnace with three or six electrodes without the need for a bottom electrode. The thyristor sets are connected in antiparallel and the three-phase alternating current is retained in phase-controlled form.

The regulating device on which the present invention is based is adapted especially to the process requirements for electric reduction furnaces in which movements of the electrodes are excluded as far as possible because they have a disruptive effect on the metallurgic melting and reduction process. In practice, the hydraulic adjustment of electrodes should compensate only for electrode consumption and respond only to larger voltage deviations.

Since the secondary current in furnaces with a knapsack circuit is not identical to the electrode string currents, a special regulating behavior is required which is made possible by the regulating system 1 according to the invention.

### REFERENCE NUMBERS

1 regulating system
2 monitoring device
3 current regulating device
4 phase angle control
5 voltage regulating device
6 personal computer
7 switching line
8 furnace switch
9 motor
10 power supply
11 furnace transformer
12 actuating device
13 power semiconductor
14 electrode
15 furnace
16 ignition line
17 hydraulic system
18 device for measuring the electrode position
19 devices for measuring and monitoring the electric quantities
20 ground connection monitoring
21 straight curve segment
22 second curve segment
Z_{T} transformer impedance
Z_{H} impedance
Z_{E} electrode impedance
Z_{B} bath impedance
PC personal computer
PLS process control system
SPS memory-programmable control
A ampere/dimension
AC alternating current
Eₙ measurement point
f grid frequency
I current
I_{EN} current
Iₚᵣᵢ primary-side current
I_{sec} secondary-side current
I_{+/-n} phase current
m 10⁻³ (milli)/number factor
k 10³ (kilo)/number factor
M 10⁶ (mega)/number factor
M motor identification/symbol
n order number
P active power
Q reactive power
S apparent power
S_{N} nominal apparent power
S_{SC} apparent power
tₐₚ time
U voltage
Uₖ short circuit voltage
U_{N} grid voltage
Uₚᵣᵢ primary-side voltage
U_{sec} secondary-side voltage
U, V, W phase electric system
VA volt ampere/dimension
V volt/dimension
Var volt-ampere-reactive/dimension
W electric work
W watt/dimension
Wh watt hours/dimension
Z_{Bn} impedance, related resistance
Z_{EN} impedance
Z_{H+/-n} impedance
Z_{Tn} impedance
α control angle, phase angle
cos φ power factor

1. Control device for AC reduction furnaces (15) with electrodes (14) having a transformer (11) and a regulating system (1) for the controlled introduction of energy into the AC reduction furnaces (15) which controls an adjusting device (17) for the electrodes (14), characterized in that the control device has controllable power-electronics AC switches (13) which are connected in the high-current conductors on the secondary side and are connected to the regulating system (1) by an ignition line (16) for supplying controlling ignition pulses, wherein the control device is constructed in such a way that brief fluctuations in the electric parameters are compensated only by the AC switches (13).

2. Control device according to claim 1, characterized in that the regulating system (1) has a phase angle control (4) of the power semiconductors (13) which regulates the effective values of the secondary currents (I_{sec}) in a continuous manner.

3. Control device according to claim 1, characterized in that the regulating system (1) is constructed in such a way that it regulates the effective values of the secondary currents (I_{sec}) in reduction furnaces in a knapsack circuit.

4. Control device according to claim 1, characterized in that the power semiconductor (13) has antiparallel-connected thyristor sets.

5. Control device according to claim 1, characterized in that the phase angle control (4) of the power semiconductors (13) responds quickly to changes in the electric parameters of the furnace process and stabilizes the power of the furnace (15).

6. Control device according to claim 1, characterized in that the adjusting device (16) for the electrodes (14) is constructed in such a way that the voltage ratios of the bath voltages are compensated in the event of gross deviations from the reference values and electrode consumption is compensated.

7. Control device according to claim 1, characterized in that the current regulation (3) and voltage regulation (5) are extensively decoupled.

8. Control device according to claim 1, characterized in that the electrodes (14) of the high-current system of the reduction furnace (15) are connected in pairs in a star connection.

9. Control device according to claim 1, characterized in that the electrodes (14) of the high-current system of the reduction furnace (15) are connected with a three-phase transformer or three single-phase transformers (11) in a knapsack circuit.

10. Control device according to claim 1, characterized in that the electrodes (14) of the high-current system of the reduction furnace (15) are connected in a triangle circuit.

11. Control device according to claim 1, characterized in that the regulating system (1) is constructed in such a way that the individual electrode currents (I_{E}) can be limited for the baking of the Söderberg electrodes.

12. Control device according to claim 1, characterized in that the regulating system (1) is constructed in such a way that the transformer currents can be limited to prevent damage from overcurrents, particularly in the voltage range below the power breakpoint.

13. Control device according to claim 1, characterized in that the regulating system (1) is constructed in such a way that the transformer output can be limited to prevent excessive temperatures of the transformers (11), particularly in the voltage range above the current breakpoint.

14. Control device according to claim 1, characterized in that the regulating system (1) is constructed in such a way that the reactive power can be limited to meet guaranteed values for the power factor (cos φ).

15. Control device according to claim 1, characterized in that the regulating system (1) is constructed in such a way that the power switches (8) and load tap changers are switchable in a virtually currentless state.

16. Control device according to claim 1, characterized in that the regulating system (1) is constructed in such a way that additional dead times and/or hysteresis are provided in the adjustment of the electrodes (14).
